(19) United States
(12) Patent Application Publication
(10) Pub. No.: US 2015/0319943 A1
(43) Pub. Date: Nov. 12, 2015

(54) A PLANT WATERING DEVICE

(71) Applicants: Gregory Lawrence Leslie, New South Wales (AU); Bruce Gregory Sutton, New South Wales (AU); Alice Antony, New South Wales (AU)

(72) Inventors: Gregory Lawrence Leslie, New South Wales (AU); Bruce Gregory Sutton, New South Wales (AU); Alice Antony, New South Wales (AU)

(73) Assignees: NEWSOUTH INNOVATIONS PTY LIMITED, New South Wales (AU); THE UNIVERSITY OF SYDNEY, New South Wales (AU)

(21) Appl. No.: 13/983,646

(22) PCT Filed: Feb. 4, 2012
(86) PCT No.: PCT/AU2012/000093

§ 371 Date: Oct. 21, 2013

(51) Int. Cl. A01G 27/00; B32B 37/18; B32B 37/12; A01G 27/04

(52) U.S. Cl. CPC A01G 27/008; A01G 27/04; B32B 37/18; B32B 37/12; B32B 2410/00

(57) ABSTRACT

Disclosed herein is a plant watering device (10) comprising a vessel, for example a tube (14), arranged to be fastened to at least one plant propagule. The tube 14 is further arranged such that when the at least one propagule (18) is so fastened water received by the tube (14) is drawn by the at least one propagule (18) through a portion of the tube (14).

### BACKGROUND OF THE INVENTION

The present invention generally relates to irrigation, and specifically but not exclusively to a watering device that may have fastened thereto at least one plant propagule, a method of making the plant watering device, an adhesive for fastening the device to the at least one propagule, and a method of deploying the plant watering device.

The steps of establishing a crop generally comprise forming a furrow in soil, distributing plant propagules (for example seeds or alternatively any of cuttings, spores, stems, tubers, leaves etc.) in the furrow, closing the furrow and then irrigating the soil to cause the propagules to grow into established plants.

The propagules are preferably distributed along the furrow such that adjacent plants that grow from the propagules are separated by a predetermined distance that maximises crop yield. Consequently, it may be desirable during the step of distributing the propagules to space them apart according to the preferred spacing. This may be in practice, however, difficult or impractical, especially when a relatively large area of land is planted. An alternative is to plant an excess of propagules and subsequently remove the excess plants to obtain close to the predetermined spacing between adjacent plants. This is, however, impractical for many crops.

Common forms of irrigation are surface irrigation and various forms of sprinkler irrigation in which an entire field is irrigated, including areas of the field from which the propagule and plants cannot draw water. Water not taken up by the propagules and plants is wasted. While various forms of localized irrigation have been developed, these are still somewhat indiscriminant in their application of water. Furthermore, it is notoriously difficult for farmers to know when enough water has been applied to the field. It is common practice to apply more water—sometimes many times more—to the field than the plants can take up. Over watering may assist fungus and other organisms attack the propagule, degrade soil structure, and wash away nutrients and fertilizers, any of which may result in a significant reduction in yield. Over watering may result in water logging of the soil, in which case most to all soil pores are full of water. The root environment may then become anaerobic leading to loss of active root membrane transport of water and nutrients. Ethylene—a hormone usually produced when a plant is wounded—may also be produced in the shoots of waterlogged plants. It may also be difficult to ensure when using localised irrigation that the propagules are located where the water is applied.

### SUMMARY OF THE INVENTION

According to a first aspect of the invention there is provided a watering device comprising a tube arranged to be fastened to at least one plant propagule, the tube further being arranged such that when the at least one propagule is so fastened water received by the tube is drawn by the at least one propagule through a portion of the tube having an intrinsic water resistance in the range of 10¹⁰ m⁻¹ to 10¹³ m⁻¹.

According to a second aspect of the invention there is provided a watering device comprising at least one plant propagule fastened to a tube, the tube being arranged for water received by the tube to be drawn by the at least one propagule through a portion of the tube having an intrinsic water resistance in the range of 10¹⁰ m⁻¹ to 10¹³ m⁻¹.

In an embodiment, the at least one propagule is fastened to an exterior surface of the tube by an adhesive arranged to draw water through the portion and deliver it to the propagule. The adhesive may comprise a plurality of capillaries that draw the water and deliver it to the at least one propagule. Each of the plurality of capillaries may comprise at least one wicking filament. The at least one wicking filament may comprise cellulosic fibre.

In an embodiment, the propagule is a seed.

In an embodiment, the portion of the tube has an intrinsic water resistance in the range of 10¹¹ m⁻¹ to 10¹² m⁻¹.

According to a third aspect of the invention there is provided a watering device comprising:

a vessel arranged to be fastened to at least one plant propagule, the vessel further being arranged such that when the at least one propagule is so fastened water received by the vessel is drawn through a portion of the vessel by the propagule.

In an embodiment, the at least one propagule is fastened to the vessel.

According to a fourth aspect of the invention, there is provided a watering device comprising:

at least one plant propagule fastened to a vessel, the vessel being arranged for water received by the vessel to be drawn through a portion of the vessel by the propagule.

In an embodiment, the propagule is disposed adjacent to a portion of the vessel having an intrinsic water resistance in the range of 10¹⁰ m⁻¹ to 10¹³ m⁻¹. The propagule may be disposed adjacent to a portion of the vessel having an intrinsic water resistance in the range of 10¹¹ m⁻¹ to 10¹² m⁻¹.

In an embodiment, the propagule is adjacent to an exterior surface of the vessel.

In an embodiment, the propagule is adjacent to a wall portion of the vessel.

In an embodiment, the propagule is fastened to the vessel by an adhesive. The propagule may be fastened to the vessel by a blob of adhesive disposed between an exterior surface of the vessel and the propagule. The adhesive may be arranged to draw water through a portion of the vessel and deliver it to the propagule. The adhesive may comprise a plurality of capillaries which draw the water and deliver it to the propagule. Each of the plurality of capillaries may comprise at least one wicking filament. The at least one wicking filament may comprise cellulosic fibre. Each of the at least one wicking filament may have a length of between 1 micrometer and 100 micrometers. Each of the at least one wicking filaments may have a diameter of between 1 micrometer and 100 micrometers. The adhesive may comprise between 10% and 90% by volume of capillary. The adhesive may comprise agar. The adhesive may comprise polymer. The polymer may comprise polyacrylamide.

In an embodiment, the vessel has a flap behind which the propagule is disposed. The flap may be secured. The flap may be secured with adhesive.

In an embodiment, the vessel comprises a tube. The tube may comprise a wall in which the propagule is disposed. The tube may be flexible.

In an embodiment, the propagule is a seed.

According to a fifth aspect of the invention, there is provided an adhesive comprising a curable component and a plurality of wicking filaments suspended in the curable component, the filaments being able to draw water through the curable component when cured.

In an embodiment, the curable component comprises agar.

In an embodiment, the curable component comprises at least one of a polymer, a hydrogel and an aerogel. The polymer may comprise at least one of polyacrylamide and polyacrylate.

In an embodiment, the wicking filaments comprise cellulosic fibres. The adhesive may comprise between 10% and 90% by volume of the wicking filament. The wicking filaments may have a length of between 10 micrometers and 50 micrometers. The wicking filaments may have a diameter of between 1 micrometer and 2000 micrometers.

In an embodiment, the adhesive comprises water extractable by a plant propagule. The extractable water may be present in sufficient quantity to meet the propagule's water requirements for at least one of germination and establishment.

In an embodiment, the adhesive comprises a substance extractable by a plant propagule and when so extracted the substance promotes the growth of the propagule.

In an embodiment, the adhesive comprises a substance that inhibits growth of an organism other than that of a plant propagule.

According to a sixth aspect of the invention there is provided a method of making a watering device, the method comprising the steps of fastening at least one plant propagule to a portion of a tube, the portion being permeable to water.

In an embodiment, the method comprises the steps of:

applying an adhesive to the tube which has a portion that is permeable to water; and

applying the at least one plant propagule to the applied adhesive.

In an embodiment, the portion has an intrinsic water resistance in the range of 10¹⁰ m⁻¹ to 10¹³ m⁻¹. The portion may have an intrinsic water resistance of 10¹¹ m⁻¹ to 10¹² m⁻¹.

In an embodiment, the method uses an adhesive according to the fifth aspect of the invention.

In an embodiment, the propagule comprises a seed.

According to a seventh aspect of the invention, there is provided a method of disposing at least one plant propagule in a field, the method comprising the steps of:

fastening the at least one plant propagule to a tube; and

disposing the tube in a field.

In an embodiment, the method comprises the steps of:

applying an adhesive to the tube which has a portion that is permeable to water;

applying the at least one propagule to the applied adhesive; and

disposing the tube in the field.

In an embodiment, the method comprises the step of introducing water into the tube.

In an embodiment, the portion has intrinsic water resistance in the range of 10¹⁰ m⁻¹ to 10¹³ m⁻¹. The portion may have intrinsic water resistance in the range of 10¹¹ m⁻¹ to 10¹² m⁻¹.

According to an eighth aspect of the invention there is provided a method according to the seventh aspect of the invention wherein the adhesive is according to the fifth aspect of the invention.

In an embodiment, the propagule comprises a seed.

In an embodiment of a plant watering device according to any one of the preceding aspects of the invention, the vessel or tube can at least in part collapse to a tape-like form.

In some embodiments of a plant watering device according to any one of the preceding aspects of the invention, the portion is preferentially permeable to water over a salt dissolved in the water. The plant watering device may provide desalination of water having the salt dissolved therein. The salt may be sodium chloride.

For any one of the above aspects of the invention, the intrinsic water resistance is for temperatures from 15 degrees centigrade to 25 degrees centigrade.

Were possible, any features of any of the above aspects of the invention may be combined.

### BRIEF DESCRIPTION OF THE DRAWINGS

Embodiments of the invention will now be described, by way of example only, with reference to the accompanying figures in which:

FIG. 1 is a schematic diagram of an embodiment of a watering device, from a perspective view;

FIG. 2 depicts a section of the watering device of FIG. 1 in an example application, disposed in soil;

FIG. 3 shows a section of an adhesive of FIG. 1 in detail that reveals capillaries in the adhesive; and

FIG. 4 shows a transverse section of another embodiment of a plant watering device

### DETAILED DESCRIPTION

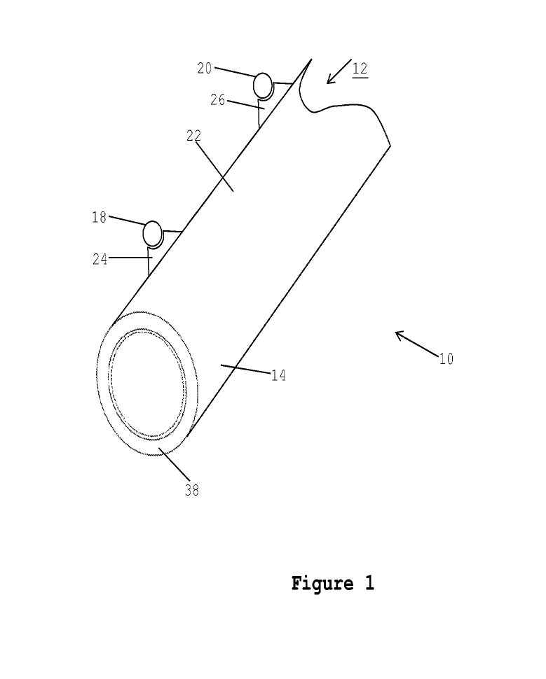

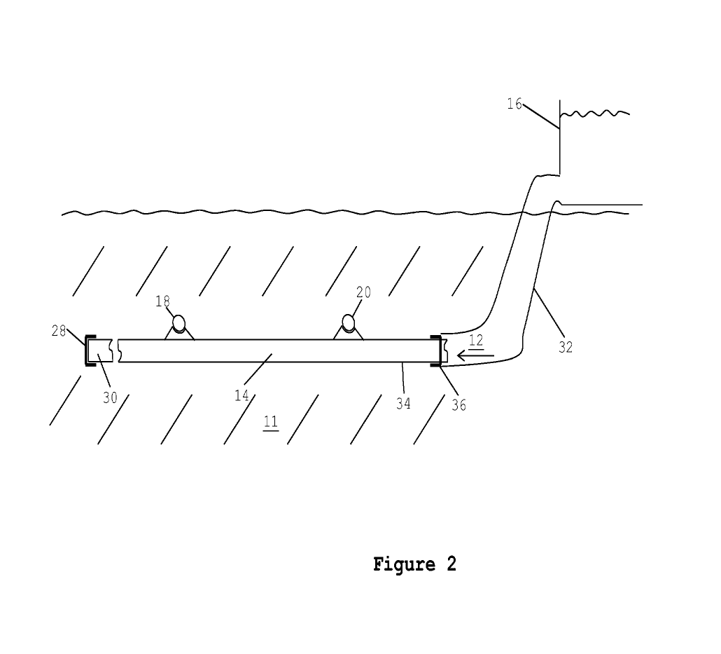

FIG. 1 is a schematic diagram of an embodiment of a watering device generally indicated by the numeral 10. FIG. 2 depicts a section of the watering device of FIG. 1 in an example application, disposed in soil 11. This embodiment of a watering device 10 has a vessel having a flexible tube 14 that receives water 12 from, for example, a tank 16, or alternatively from a dam, river, aquifer, artesian basin or other source of water. A pipe 32 delivers water from the tank 16 to a proximal end 34 of the tube 14. The pipe is held to the end 34 of the tube 14 with a constricting collar 36, for example, although any suitable means may be employed such as adhesive, shrink fit, etc. The tube 14 may, in some embodiments, extend to and connect with an outlet of the tank. In the embodiment of FIG. 1, the water moves under the influence of gravity into the tube, but the water may, in some other embodiments, be pumped into the tube 14. Generally, the water pressure in the tube is modest, much less than that required for desalination of water by reverse osmosis, for example. In this but not necessarily in other embodiments, a cap 28 closes a distal end 30 of the tube 14 so that water does not leave via an opening at the end 30. In alternative embodiments the end 30 is closed by other suitable means, such as by inserting a plug in the opening or by crimping or pinching the end. In other embodiments the water is free to flow out of the tube.

Plant propagules, such as the seeds indicated by numerals 18 and 20, are disposed adjacent to an exterior surface 22 of a wall 38 of the tube 14. In this but not all embodiments the propagules 18 & 20 are fastened to the exterior surface by blobs of adhesive 24 & 26 that are each disposed between the exterior surface 22 of the tube 14 and the respective propagule. The spacing of the propagules along the tube may be commensurate with a predetermined distance that maximizes crop yield. In another embodiment, the glue is applied as a line and the propagules are spaced along that line. Generally the adhesive may be applied in any fashion that fastens the propagules.

The tube 14 intrinsically resists water moving from the tube's interior to the tube's exterior, through the wall 38 and exterior surface 22. This resistance may be overcome by the propagules which provide a water potential gradient that draws the water out of the tube 14. Roots of plants that grow from the propagules may also provide the necessary water potential gradient to draw water from the tube. The tube wall may, for example, be porous rubber or polymer lined with a membrane (shown in dashing) which provides the majority of the intrinsic water resistance. Generally, any suitable tube may be used.

The membrane may be a reverse osmosis membrane, such as a cellulose acetate membrane. In alternative embodiments, the membrane may be an ultrafiltration and/or a nanofiltration membrane. The membrane may be prepared from synthetic monomers and polymers, such as a dense polymer membrane. An example is a polyamide membrane deposited using interfacial polycondensation. The tube may be fabricated by providing a water permeable tube, and then forming a preferentially water permeable membrane adjacent an inside surface of the tube 14. The membrane can be deposited using techniques such as interfacial polycondensation, interfacial polymerization (saturating the surface with a monomer and then polymerizing) and phase inversion of a polymer from a liquid to a solid phase. Microporous films may be cast or spun from organic polymers by various proprietary techniques based on the phase inversion casting process. In the phase inversion process a well solvated polymer is induced to precipitate, or “gel” as a solid film. The phase change for the polymer in the solvated (liquid state) to the solid state can be induced by reaction with a non solvent or by temperature. For example, crystalline cellulose acetate will dissolve in a mixture of acetone and pyridine, then precipitate as a microporous film at the interface between the organic solvent and an aqueous solution. A similar change of phase is observed with polypropylene, which will exist in a solvated form in an organic solvent at over 150° C. and will revert to a crystalline form at a temperature of 150° C.

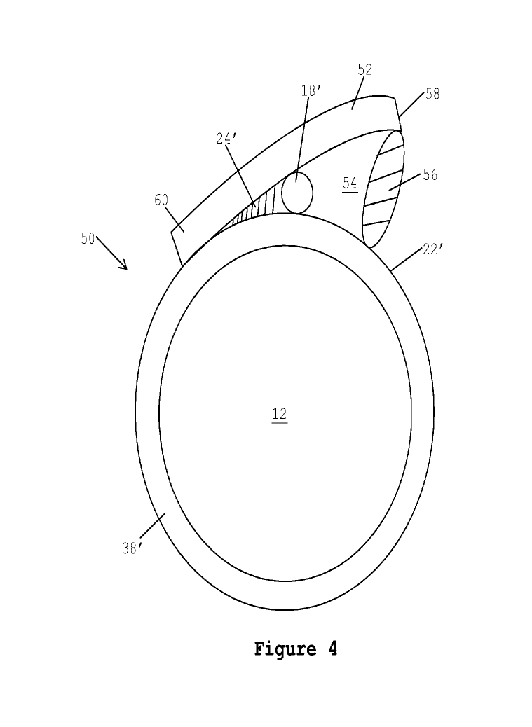

The tube 14 may be formed, for example, by first casting the membrane as a sheet, bringing opposing edges of the sheet together and then subsequently fixing the edges together to form the tube. The fixing of the edges may be achieved by heating and/or anealling, for example, or through the use of an adhesive. The edges may overlap to form a flap similar to the flap indicated by numeral 52 in FIG. 4. A use of such a flap is discussed with reference to FIG. 4 below.

Because cellulose acetate is hydrolysed above pH 5.5 it is possible to dissolve a cellulose acetate tube in situ by flushing the line with an alkaline solution. As cellulose is readily biodegradable, this type of subsoil drip irrigation tube would afford a more sustainable approach in contrast to the current contamination of fields with persistent polyethylene lines. This advantage may be present for embodiments in which the membrane and the tube are the same.

Intrinsic water resistance Rₘ, having units of m⁻¹, is defined by:

$$J = \frac{Δ P - π}{μ {R}_{m}}$$

where J is the water flux having units of m³/m²/s, ΔP is the difference of the internal and external water pressure, π is the osmotic pressure drawing the water from the tube and μ is the viscosity. The tube wall 38, at least in some embodiments, has an intrinsic water resistance in the range of 10¹⁰ m⁻¹ to 10¹³ m⁻¹, although the applicants are of the view that superior results are obtained if the tube wall has an intrinsic water resistance in the range of 10¹¹ m⁻¹ to 10¹² m⁻¹. Especially in the latter range, the water 12 delivered to the tube 14 will not, to any significant extent, move of its own accord through the tube wall 38. However, the water 12 can be drawn through the wall 38 if there is sufficient water potential gradient. The water potential gradient required to draw the water through the wall increases with increasing intrinsic resistance. If the intrinsic resistance of the wall 38 is high enough, say 1×10¹¹, then a reasonably dry soil with a matric potential of, say, −10 bar will not have a high enough water potential to draw significant amounts of water through the wall 14 of the tube 14. Thus only a fraction of the water that is drawn out of the tube may not be directly used by the propagule and plant, saving considerable amounts of water. Simultaneously, because, as noted above, the soil is not significantly wetted by the tube, common problems of over-irrigation noted earlier, such as fungal and other plant diseases and degradation of the soil structure, will be avoided.

The intrinsic resistance of the tube may be chosen to suit the local prevailing soil moisture, propagule type, the salinity of the water 12, and any other parameters. Some tubes with an intrinsic resistance at the upper end of the range, say 10¹² m⁻¹, may pass water through the wall while inhibiting the passage of salt through the wall. Thus the water 12 may be brackish in certain circumstances. A tube incorporating a cellulose acetate membrane in the wall, for example, may desalinate brackish water, the process being driven by a water potential from the propagule or plant without the application of high pressures.

In an alternative embodiment, the intrinsic resistance is at the lower end of the range, in which case the tube has similar water permeability to a porous rubber hose adapted for subsurface irrigation as it is traditionally understood. In this case, the water will be drawn through the tube wall by the water potential of dry soil.

Polymeric thin film membranes that have an intrinsic resistance of 10¹⁰ m⁻¹ to 10¹³ m⁻¹ have been used for pressure driven, liquid phase, separation processes including microfiltration and reverse osmosis. Microfiltration membranes may have a porous structure, whereas, reverse osmosis membranes may have a non-porous structure. Some embodiments use a membrane having a non-porous structure with a resistance in the range of 10¹¹ m⁻¹ to 10¹² m⁻¹. Generally, low pressure reverse osmosis and nanofiltration membranes have a resistance in this range.

If the wrong adhesive is disposed between the exterior surface 22 of the tube 14 and the propagules 18 & 20 then the adhesive may act as a barrier to the transport of water from the interior of the tube 14 to the propagules. In this case the propagule is unlikely to flourish. For example, adhesives that cure to form a dense monolithic polymer have this property. The applicants have found that some hydrogels when used as an adhesive dry out to form a barrier to the transport of water.

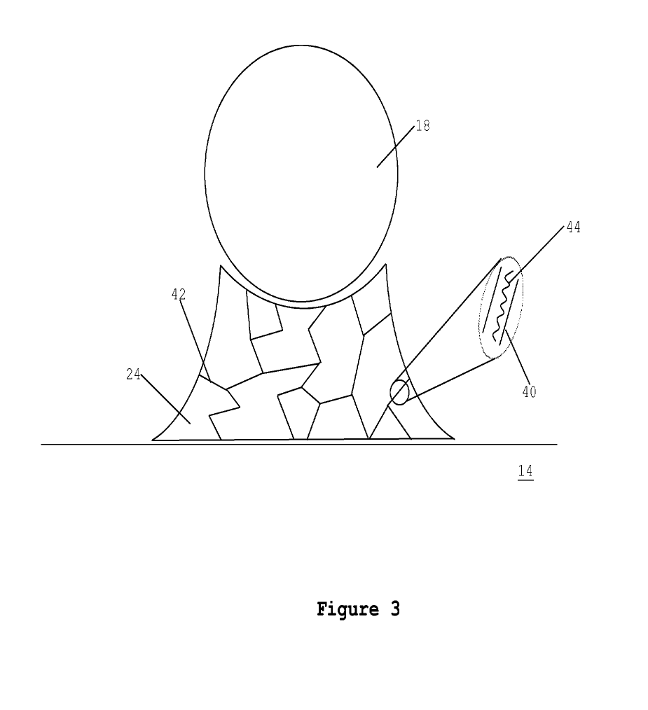

Consequently, in the present embodiment the adhesive 24 & 26 is arranged to draw water through a portion of the tube and delivers the water to the propagule. FIG. 3 shows a detail of an adhesive 24 of FIG. 1 that reveals capillaries such as 40, 42 in the adhesive. The adhesive 24 & 26 comprises a plurality of capillaries which draw the water and deliver it to the propagule. The capillaries may form, for example, a network of capillaries. Alternatively, some or all of the capillaries may not communicate with others. The capillaries may be hollow, but in the present embodiment at least some of the capillaries comprise at least one wicking filament in the form of cellulosic fibre 44. Generally, the wicking filaments have a length of between 1 micrometer and 100 micrometers. The wicking filaments generally have a diameter of between 1 micrometer and 2000 micrometers. The adhesive may comprise between 10% and 90% by volume of capillary, but the applicants presently believe that 50% by volume may give a superior result. Generally, any suitable capillaries may be used at any suitable conventration.

The adhesive may comprise agar, and may be an agar glue. Some other embodiments of the adhesive comprise a polymer such as a polyacrylamide, and polyacrylate. Not withstanding the above discussion, some embodiments of the adhesive may comprise a hydrogel and/or an aerogel.

The present embodiment of the adhesive 24 & 26 contains substances, such as fertilizers and enzymes, that promote the growth of the propogule, although other embodiments may not. The adhesive comprises water extractable by a propagule to stimulate the propagule's germination, particularly for a seed that has a hard waxy coating such as a corn kernel. The adhesive comprises substances that inhibit the growth of organisms other than that of a plant propagule, such as fungicides. Many seeds, such as Sorghum, generally benefit greatly from organism growth inhibitors.

FIG. 4 shows a transverse section of another embodiment of a plant watering device generally indicated by the numeral 50, where parts similar to parts of the embodiment shown in FIG. 1 are similarly numbered. The watering device 50 has a flap 52 defining a cavity 54 behind which adhesive 24′ and the at least one propagule 18′ is disposed. The flap may protect the seed. The propagule, at least in this embodiment, is in contact with the adhesive. In an alternative embodiment the seed is fastened merely by pressure from the flap. A distal end 58 of the flap 52 may be secured with another blob of adhesive 56 adjacent the end 58 and bridging the cavity 54, but not necessarily. In other embodiments, for example, the flap may be secured with a string looped around the tube. Generally, any suitable securing means may be used. The flap may be paper, cardboard, a thin fabric or any other suitable material attached adjacent a proximal end 60 to the exterior surface of the tube wall 38′, with an adhesive for example.

The embodiment of FIG. 4 may provide superior resistance to crushing, particularly when adhesive is located on either side of the propagule 18′, or when the flap 52 is stiff. The adhesive may act as a crush resistant structure. The flap may prevent the seed from being accidentally dislodged from the tube 14.

In another embodiment, the propagule is disposed within the tube wall.

A method of fabricating an embodiment of a watering device, such as that shown in FIG. 1, and its deployment will now be described. In a first step, blobs of adhesive are placed along a tube having a chosen intrinsic resistance. In a second step, at least one propagule is applied to each blob of adhesive. The spacing of the propagules along the tube may be commensurate with a predetermined distance that maximizes crop yield. In a third step, a furrow is formed in a field. In a fourth step, the tube with the propagules fastened to it is disposed along the furrow. The tube may be take the form of a drip irrigation tape, which is a convenient form because drip irrigation tape may be run off a spool on the back of a tractor into the prepared furrow. In a fifth step, the furrow is covered with soil. In a sixth step, water is introduced into the tube.

Some embodiments may have some of the following advantages:
Propagules, being regularly spaced along a tube, are relatively easily disposed in soil in a predetermined spaced-apart relationship to maximise crop yield.
Because the propagules are spaced apart by a predetermined distance that maximises crop yield there is no need to remove excess plants which would otherwise be a waste of seed (or other propagules) and labour.
The propagules are disposed at the point of irrigation with relative ease.
The propagules and plants draw only the amount of water they need from the irrigation system and there is no need to apply significantly more water than the plants take up.
The tube is biodegradable.
Because the plant draws the water from the irrigation system, irrigation is extremely localised even compared to other forms of localised irrigation. Water is provided to the plant in preference to the surrounding soil.
The resulting water transport is under tension in fine soil pores that can support that tension; the bigger pores are full of air.

It will be understood to persons skilled in the art of the invention that many modifications may be made without departing from the spirit and scope of the invention. For example, the tube may have a transverse section of any suitable shape, such as square, rectangular, triangular, oval, circular, and an arbitrary shape. The shape may change with the pressure within the tube. A propagule may be fastened on a cap or plug, for example, which terminates the tube. The vessel may be in the form of one of a container, pot, bowl, gutter or trench, for example.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

1-59. (canceled)

60. A watering device comprising:
a vessel or a tube arranged to be fastened to at least one plant propagule, the vessel or tube further being arranged such that when the at least one propagule is so fastened water received by the vessel or tube is drawn through a portion of the vessel or tube by the propagule.

61. A watering device comprising:
at least one plant propagule fastened to a vessel or a tube, the vessel or tube being arranged for water received by the vessel or tube to be drawn through a portion of the vessel or tube by the propagule.

62. A watering device defined by claim 61 wherein the propagule is disposed adjacent to a portion of the vessel or tube having an intrinsic water resistance in the range of 10¹⁰ m⁻¹ to 10¹³ m⁻¹.

63. A watering device defined by claim 61 wherein the propagule is disposed adjacent to a portion of the vessel or tube having an intrinsic water resistance in the range of 10¹¹ m⁻¹ to 10¹² m⁻¹.

64. A watering device defined by claim 61 wherein the propagule is fastened to the vessel or tube by an adhesive.

65. A watering device defined by claim 61 wherein the propagule is fastened to the vessel or tube by a blob of adhesive disposed between an exterior surface of the vessel or tube, and the propagule.

66. A watering device defined by claim 64 wherein the adhesive is arranged to draw water through a portion of the vessel or tube and deliver it to the propagule.

67. A watering device defined by claim 66 wherein the adhesive comprises a plurality of capillaries which draw the water and deliver it to the propagule.

68. A watering device defined by claim 67 wherein each of the plurality of capillaries comprises at least one wicking filament.

69. A watering device defined by claim 68 wherein the at least one wicking filament comprising cellulosic fibre.

70. A watering device defined by claim 68 wherein each of the at least one wicking filament has a length of between 1 micrometer and 100 micrometers.

71. A watering device defined by claim 68 wherein each of the at least one wicking filaments has a diameter of between 1 micrometer and 100 micrometers.

72. A watering device defined by claim 67 wherein the adhesive comprises between 10% and 90% by volume of capillary.

73. A watering device defined by claim 64 wherein the adhesive comprises agar.

74. A watering device defined by claim 64 wherein the adhesive comprises polymer.

75. A watering device defined by claim 74 wherein the polymer comprises polyacrylamide.

76. A watering device defined by claim 61 wherein the portion is preferentially permeable to water over a salt dissolved in the water.

77. A method of making a watering device, the method comprising the steps of fastening at least one plant propagule to a portion of a tube, the portion being permeable to water.

78. A method defined by claim 77 comprising the steps of:
applying an adhesive to the tube which has a portion that is permeable to water; and
applying the at least one plant propagule to the applied adhesive.

79. A plant watering device defined by claim 61 wherein the vessel or tube can collapse to a tape-like form.
